(19) United States
(12) Patent Application Publication
(10) Pub. No.: US 2014/0110651 A1
(43) Pub. Date: Apr. 24, 2014

(54) GUARDRAIL

(71) Applicants: AARON JAMES COX, Roseville, CA (US); Brent S. Sindorf, Roseville, CA (US)

(72) Inventors: AARON JAMES COX, Roseville, CA (US); Brent S. Sindorf, Roseville, CA (US)

(73) Assignee: ENERGY ABSORPTION SYSTEMS, INC., Dallas, TX (US)

(21) Appl. No.: 14/023,150

(22) Filed: Sep. 10, 2013

Related U.S. Application Data
(60) Provisional application No. 61/700,572, filed on Sep. 13, 2012.
(60) Provisional application No. 61/751,007, filed on Jan. 10, 2013.

(51) Int. Cl. E01F 15/04; F16G 11/10

(52) U.S. Cl. CPC E01F 15/0461; E01F 15/04; F16G 11/10
USPC 256/13.1; 24/115 F

(57) ABSTRACT

A guardrail system includes a plurality of posts spaced apart along a longitudinal direction and a plurality of rail sections extending between and coupled to the spaced apart posts. Each of the rail sections includes an uppermost surface. A cable extends along the longitudinal direction and is coupled to the rail sections and/or posts. The cable is vertically spaced above the uppermost surface of the rail sections. A guardrail retrofit kit includes a front anchor bracket, a rear anchor bracket, an intermediate bracket and a cable having end portions adapted to be coupled to the front and rear anchor brackets. The intermediate bracket is configured to releasably capture the cable. Methods of retrofitting a guardrail system and arresting a vehicle impacting a guardrail system are also provided.

This application claims the benefit of U.S. Provisional Application No. 61/751,007, filed Jan. 10, 2013, and U.S. Provisional Application No. 61/700,572, filed Sep. 13, 2013, the entire disclosures of which are hereby incorporated herein by reference.

### FIELD OF THE INVENTION

The present invention relates generally to a guardrail system, and in particular, to a guardrail system having a cable secured thereto above the guardrail, and to kits for retrofitting a guardrail system with the cable.

### BACKGROUND

Guardrails, as shown for example in FIGS. 13 and 14, provide significant safety advantages, namely protecting errant vehicles from leaving the roadway and/or from various roadside hazards. For proper functioning, the guardrails are positioned at a height sufficient to safely redirect the errant vehicle, without the vehicle rolling over the top of, or diving under, the guardrail. Hazards that are commonly protected by guardrails include trees, signs, culverts, bridge piers, steep edge drop-offs, and soft soil that could cause vehicle roll.

Guardrails are able to capture an errant vehicle by having the longitudinal strength to resist the vehicle impact. Specifically, the rail sections and their respective joints are stronger that the forces generated during the vehicle impact. The guardrail is typically held in place by either wood or steel posts. The posts hold the rail at the proper height and are designed to bend and/or rotate during an impact. These posts are individually relatively weak, however when taken as a system, they are able to resist the lateral loads imposed upon the rail. Additional structural strength is provided to the rail by anchoring each end of the rail, either through the use of a crashworthy end terminal, or some other means of fixing the end of the steel rail to the ground.

Crash testing is used to qualify the performance of guardrail systems, before they are able to be used as protection devices. Typically, a crash test standard, such as NCHRP 350, or MASH, is used to determine the speeds and angles of the crash test vehicles. These test standards define pass/fail criteria, and many governmental agencies allow the use of guardrail systems based on successfully passing crash tests called out by these standards. For instance a common guardrail system, known by its AASHTO designation as G4(1S) (shown in FIG. 14), has been tested and found to pass the requirements of NCHRP 350 when having an installed height (to the top of the rail) at 27¾ inches. The G4(1S) guardrail system is a commonly accepted guardrail and it has been installed on miles and miles of our nation's roads and highways.

More recently, the requirements of the NCHRP 350 standard have been reviewed by leading researchers in highway safety. Although this standard was found to be an adequate way to test highway hardware, some of its requirements may be outdated and updates were suggested. For instance, NCHRP 350 uses test vehicles that were typical of the nation's vehicle fleet when the standard was written. Since that time the vehicle fleet has changed, with a shift towards heavier SUV type vehicles having higher centers of gravity. This has led to the adoption of the MASH testing standard. This standard uses heavier test vehicles with higher centers of gravity. Specifically, under NCHRP 350, a 100 kph test of a guardrail system, such as the G4(1S), would use a 2000 kg pickup truck, with a typical center of gravity of 25 inches to 26 inches. The same test under the MASH test standard requires a 2270 kg pickup with a minimum center of gravity of 28 inches.

As such, guardrail systems that may have been successfully tested to the NCHRP 350 standard, may have a more difficult time passing the MASH standard, and may be less effective for stopping vehicles with higher centers of gravity, especially if the guardrail system has settled, or resurfacing of the road has resulted in a height to the top of the rail of less than 27¾ inches.

### SUMMARY

The present invention is defined by the following claims, and nothing in this section should be considered to be a limitation on those claims.

In one aspect, one embodiment of a guardrail system includes a plurality of posts spaced apart along a longitudinal direction and a plurality of rail sections extending between and coupled to the spaced apart posts. Each of the rail sections includes an uppermost surface. A cable extends along the longitudinal direction and is coupled to the rail sections and/or posts. The cable is vertically spaced above the uppermost surface of the rail sections.

In another aspect, one embodiment of a guardrail retrofit kit includes a front anchor bracket, a rear anchor bracket, an intermediate bracket and a cable having end portions adapted to be coupled to the front and rear anchor brackets. The intermediate bracket is configured to releasably capture the cable.

In another aspect, a cable retention bracket is adapted to releasably capture a cable. The bracket includes a web having a vertically oriented retention slot comprising upper and lower notch portions and a release slot communicating with the retention slot and opening through an edge of the web. In various embodiments, the cable retention bracket may include a tang, which is bent or broken to release the cable.

In another aspect, a method of retrofitting a guardrail system includes providing a plurality of posts spaced apart along a longitudinal direction and a plurality of rail sections extending between and coupled to the spaced apart posts, with each of the rail sections having an uppermost surface. The method further includes attaching a cable extending in the longitudinal direction to at least some of the rail sections and/or posts, wherein the cable is vertically spaced above the uppermost surface of the rail sections.

In another aspect, a method of arresting a vehicle impacting a guardrail system includes impacting at least one of the rail sections and the cable, rotating at least one of the posts and releasing said cable from at least one of said rail sections and /or posts.

In another aspect, a cable retention bracket includes a base portion adapted to be secured to a rail section and/or post and a release tang connected to the base portion. The release tang is shaped and sized to hold a cable in a non-impact condition, and is configured to fail so as to release the cable during an impact condition.

The various embodiments of the guardrail system, retrofit kit, bracket and methods of assembly and use thereof, provide significant advantages over other guardrail systems. For example and without limitation, the cables provide the system with a greater height that is more capable of arresting vehicles with a higher center of gravity. In addition, the cable and brackets may be easily and quickly installed on existing guardrail systems, allowing for easy retrofit. The embodiments also provide a low cost upgrade to installed guardrail systems, which allow them to perform adequately, without the need to be removed and replaced.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a side view of a guardrail system.

FIG. 2 is a top view of the guardrail system shown in FIG. 1.

FIG. 3 is an enlarged partial view showing a front anchor bracket secured to a rail section taken along line 3 of FIG. 1.

FIG. 4 is an enlarged partial view showing an intermediate bracket secured to a rail section taken along line 4 of FIG. 1.

FIG. 5 is a cross-sectional view of the guardrail taken along line 5-5 of FIG. 1.

FIG. 6 is an enlarged partial side view of front terminal end of the guardrail system.

FIG. 7 is a partial perspective view of a rear anchor bracket attached to a guardrail system and supporting a cable.

FIG. 8 is a partial perspective view of an intermediate bracket attached to a guardrail system and supporting a cable.

FIG. 9 is a partial perspective view of an alternative embodiment of an intermediate bracket attached to a guardrail system and supporting a cable.

FIGS. 10-12 show cross-sectional views of various alternative embodiments of an intermediate bracket.

FIGS. 13 and 14 show one embodiment of a prior art guardrail system.

### DETAILED DESCRIPTION OF THE PRESENTLY PREFERRED EMBODIMENTS

It should be understood that the term “plurality,” as used herein, means two or more. The term “longitudinal,” as used herein means of or relating to length or the lengthwise direction 61 of the guardrail or rail section, or assembly thereof. The term “lateral,” as used herein, means directed between or toward (or perpendicular to) the side of the guardrail system in a sideways direction 71. The term “coupled” means connected to or engaged with, whether directly or indirectly, for example with an intervening member, and does not require the engagement to be fixed or permanent, although it may be fixed or permanent. The term “transverse” means extending across an axis, and/or substantially perpendicular to an axis. It should be understood that the use of numerical terms “first,” “second,” “third,” etc., as used herein does not refer to any particular sequence or order of components; for example “first” and “second” web portions may refer to any sequence of such portions, and is not limited to the first and second web portions of a particular configuration unless otherwise specified.

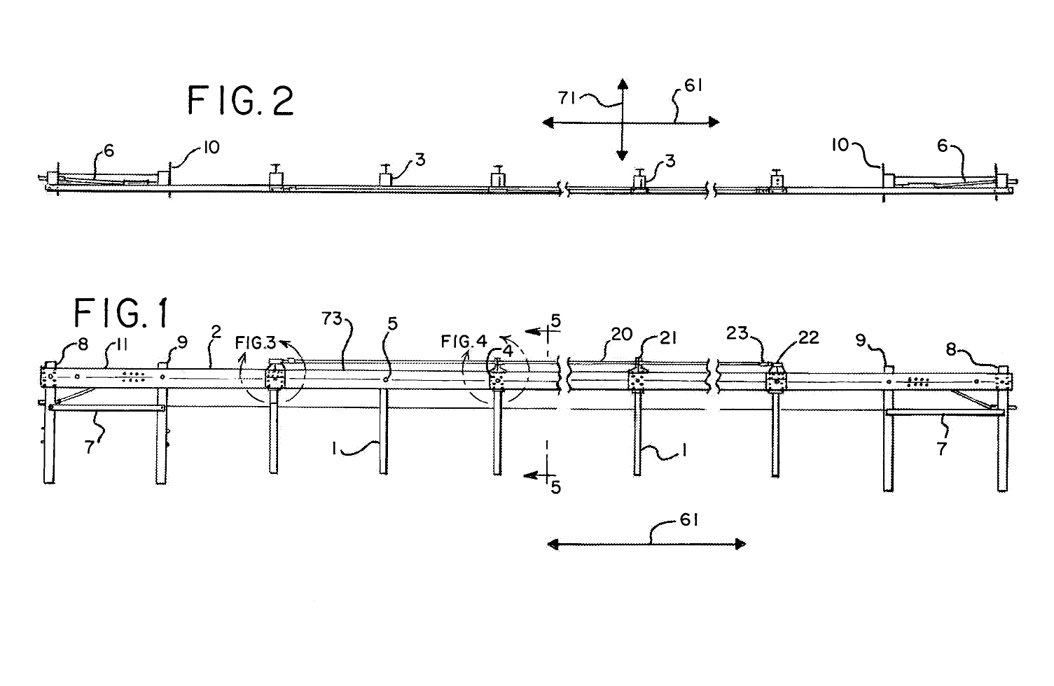

The guardrail system, shown in FIGS. 1 and 2, includes posts 1, rail sections 2, and blockouts 3, which are connected to and form part of a the post 2 in some embodiments. The rail sections 2 are held together at their ends by rail bolts 4. The rail sections are secured to the blockouts 3 and posts with long bolts 5. Although the design shown in FIGS. 1 and 2 includes blockouts 3, the guardrail upgrade or retrofit kit described here could also be used with guardrail systems that are not configured with blockouts, as well as systems that utilize thrie beam guardrail, w-beam guardrail, box beam guardrail or other shapes of guardrail. It should also be noted that there are various types of blockouts, such as 6 inch×8 inch wood blockouts, steel I-beam blockouts, polyethylene/crumb rubber blockouts, as described in U.S. Pat. No. 6,530,560, the entire disclosure of which is hereby incorporated herein by reference, and other blockouts of various sizes, shapes, and materials, all of which may be suitable. The guardrail retrofit kit may also be used with guardrail systems configured with a variety of post designs, including steel I-beam W6×8.5 posts, 6 inch×8 inch wood posts, steel weak post designs, C-shaped posts, sigma shaped posts, etc. and other known and suitable posts. It should also be understood that the cable and brackets may be incorporated into new guardrail systems, as well as existing, installed systems.

The guardrail system of FIGS. 1 and 2 is terminated on each end by anchor cable 6, which is connected to the end rail 11 and controlled-release-terminal (CRT) post 8. The anchor cable 6 transfers longitudinal forces in the rail to the CRT post 8, which is firmly anchored in the ground. The CRT post 8 is also connected to the wood post 9 by strut 7, providing additional anchorage for the guardrail system. Both the CRT post 8 and wood post 9 are provided with soil plates 10. Additional details of the end anchorage can be seen in FIG. 6. Although this arrangement provides the necessary structure to adequately anchor the end rail 11, other methods could be used, such as the end terminals disclosed in U.S. Pat. No. 4,928,928 and U.S. Pat. No. 8,215,619, the entire disclosure of which is hereby incorporated herein by reference. Appropriate structural anchorages may also be provided by transitions to bridge rails and other guardrail systems.

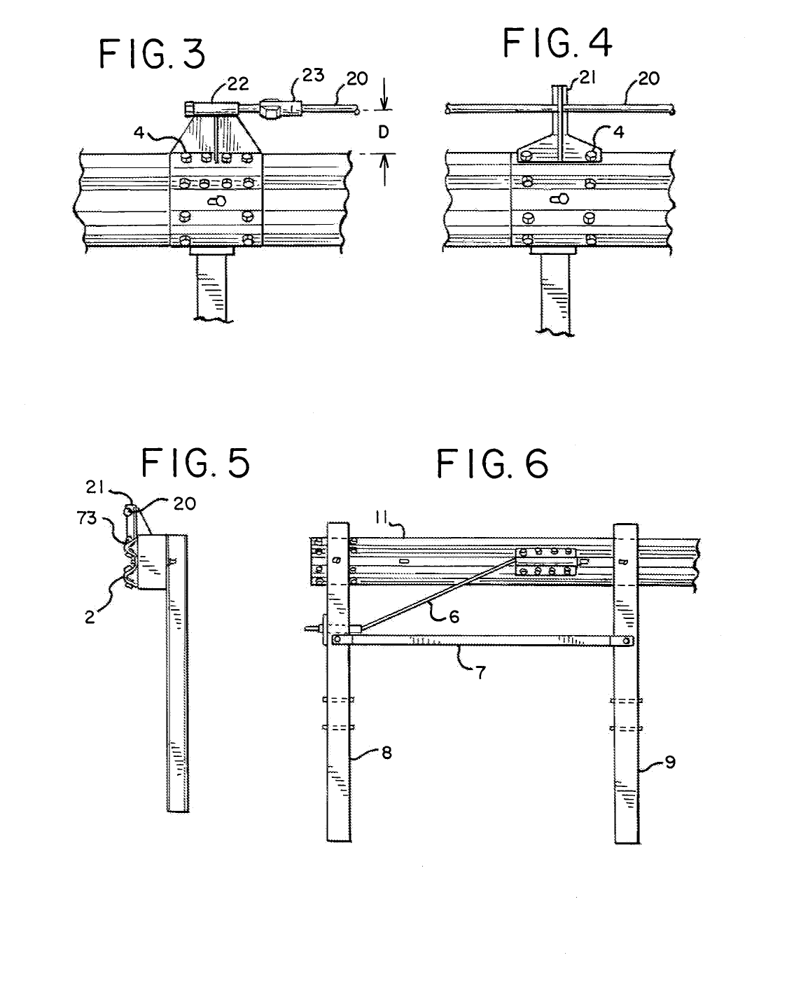

Also shown in FIGS. 1 and 2 is a guardrail kit consisting of cable 20, intermediate cable bracket 21, cable end 23, and cable end anchor brackets 22. Additional details of these components can be seen in FIGS. 3, 4, 5, 7, and 8. FIGS. 4, 5, and 8 provide detailed views of cable 20 and intermediate cable bracket 21. As shown in these figures, in this embodiment, the intermediate cable bracket 21 is attached to the top of the guardrail rail sections using two of the existing rail bolts 4 that secure the rail sections together. In various embodiments, the cable 20 is vertically spaced above an uppermost surface 73 of the rail sectionsa distance D, for example at or between 2 to 8 inches thereabove. It should be understood that the anchor brackets 22 and intermediate brackets 21 may be secured to the rail sections 2, posts 1 and/or blockouts 3, and/or combinations thereof.

As shown in FIG. 5, the intermediate cable bracket 21 is sized so that the cable 20 is held at a height of 31 inches above the ground, when the top, or uppermost surface 73 of the rail section 2 is at 25 inches. Of course, it should be understood that other geometries are possible, for instance lower or higher guardrails may require larger or smaller cable brackets, respectively, to attain a 31 inch height. It should also be understood that the cable may be held at different heights, higher or lower than 31 inches, depending upon the application and that in some applications more than one cable may be used, for example with the cables being vertically spaced one above another.

FIG. 8 is a perspective view of the guardrail kit showing additional details of the intermediate cable bracket 21, otherwise referred to as a cable retention bracket. The intermediate cable bracket in FIG. 8 includes a rear gusset 31, which rests upon and engages blockout 3. It should be understood that rear gusset 31 could be of many different shapes, depending upon the type of blockout 3 that is used, or whether the guardrail system even has a blockout. It should also be understood that some designs may not have a rear gusset 31.

As shown in FIG. 8, the intermediate cable bracket 21 includes a cable release structure. In one embodiment, the cable release structure includes a slot 30 that releasably captures the cable 20 at a proper height. As shown in FIG. 8, slot 30 has special features to hold the cable in place, while allowing it to be released at the appropriate time during an impact by a vehicle with a guardrail that has been equipped with the guardrail kit. Specifically, slot 30 has a lower notch portion 32 which holds the cable 20 at the appropriate height during a non-impact condition, i.e., while a vehicle is not impacting the guardrail system. At the beginning of an impact event, the guardrail and cable will be subjected to a number of dynamic forces that initiate vibration in the cable. During this initial part of the impact event, the post 1 is in its fully upright orientation, as shown in FIG. 8 and the lower notch 32 acts to retain the cable 20 and hold it at its proper height, so that it can restrain the impacting vehicle.

As the impact event progresses, the guardrail 2 and cable 20 will be engaged by the impacting vehicle and the vehicle will apply lateral loads to the guardrail 2 and cable 20. This will cause the guardrail 2 and cable 20 to apply lateral loads to the top of post 1, causing it to rotate or bend away from the impacting vehicle, generally in the direction 40, indicated. This rotation will cause the cable to generally move from the lower notch portion 32 towards an upper notch portion 33. During this portion of the impact event there still may be much movement and vibration in the cable and the cable may not actually move to the upper notch portion 33, but rather lower notch 32 and upper notch 33 work together to retain the cable at approximately the same height as it was initially.

Finally, the impact event will progress to the point that there will be significant movement of the top of post 1 and this will begin to pull cable 20 downwards, below its initial height. If the cable is not released, the cable 20 may be pulled beneath the impacting vehicle, with the vehicle subsequently overriding the barrier. To avoid this situation, slot 34 is provided in the web of cable bracket 21. The slot 34 communicates between the slot 30 and an edge of the web, or side of the intermediate cable bracket 21. Slot 34 allows the cable to be released at this point of the event. Since guardrail 2 continues to be loaded laterally by the impacting vehicle, it continues to push post 1 in direction 40, however at this point the cable 20 is free to remain at its appropriate height. It should be noted a typical guardrail kit would contain include a plurality of intermediate cable brackets 21 and the length of cable 20 would be much longer than the length of the impact. This means that not all of the posts 1 are rotated over at the same time, such that not all of the cable brackets 21 release the cable 20 at the same time. As such, the cable 20 will be released by some cable brackets 21 in the impact zone, but will continue to be supported by other intermediate cable brackets 21, and the front and rear anchor brackets 22, outside of the impact zone.

As shown in FIG. 8, the intermediate cable bracket 21 includes an upper tang 35, which defines the upper notch portion 33, and which may be designed to fail at a predetermined level, by way of bending, shearing, breaking, etc. This feature may be used to ensure that at a predetermined level of force, the cable is released, even if it is not aligned with and pulled through the slot 34.

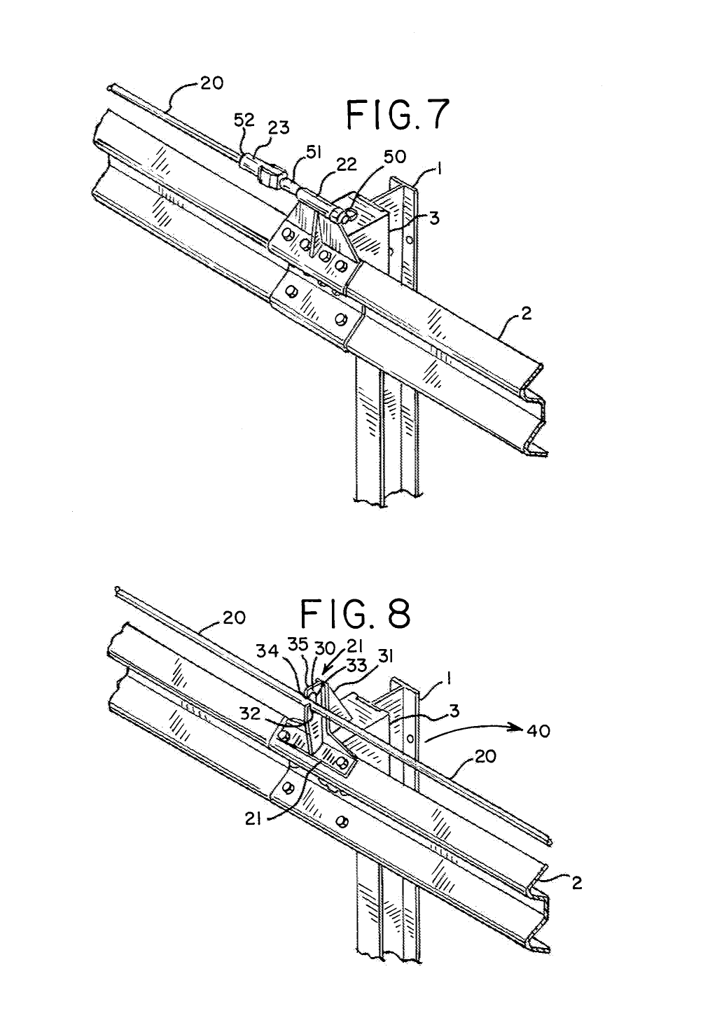

FIGS. 3 and 7 show the details of the termination of the ends of the guardrail kit. Each of the cable terminal ends includes a cable end anchor bracket 22 and a cable end 23. The cable end 23 includes a threaded stud portion 51 that passes through a bore in the cable end anchor bracket 22. The cable end 23 is then adjusted and held in place with a nut 50. The cable end also has an attachment portion 52 that can be connected to the cable 20, either by swaging, potting with epoxy, or other suitable means. Attachment of the cable end 23 and adjustment of the nut 50 allows for the installer to properly tension the cable 20. In practice a tension of 3100 lbs at 70 degrees Fahrenheit has been found to be suitable. It should be understood that different levels of tension at different temperatures may work equally well.

Intermediate cable bracket 21 and cable end anchor bracket 22 are fabricated from bent steel plates which are welded together and then galvanized in one embodiment. Other fabrication methods and materials are possible, for instance other metals, plastics and like materials could be used. These parts also may be cast, stamped, or injection molded, depending upon the materials used. In one embodiment, cable 20 is made of ¾ inch diameter 3×7 strand galvanized steel cable. Although steel cable is used in this embodiment, alternative embodiments could use rods, flat bars, ropes and other shapes in a variety of materials including steel, other metals, nylon, Kevlar and etc.

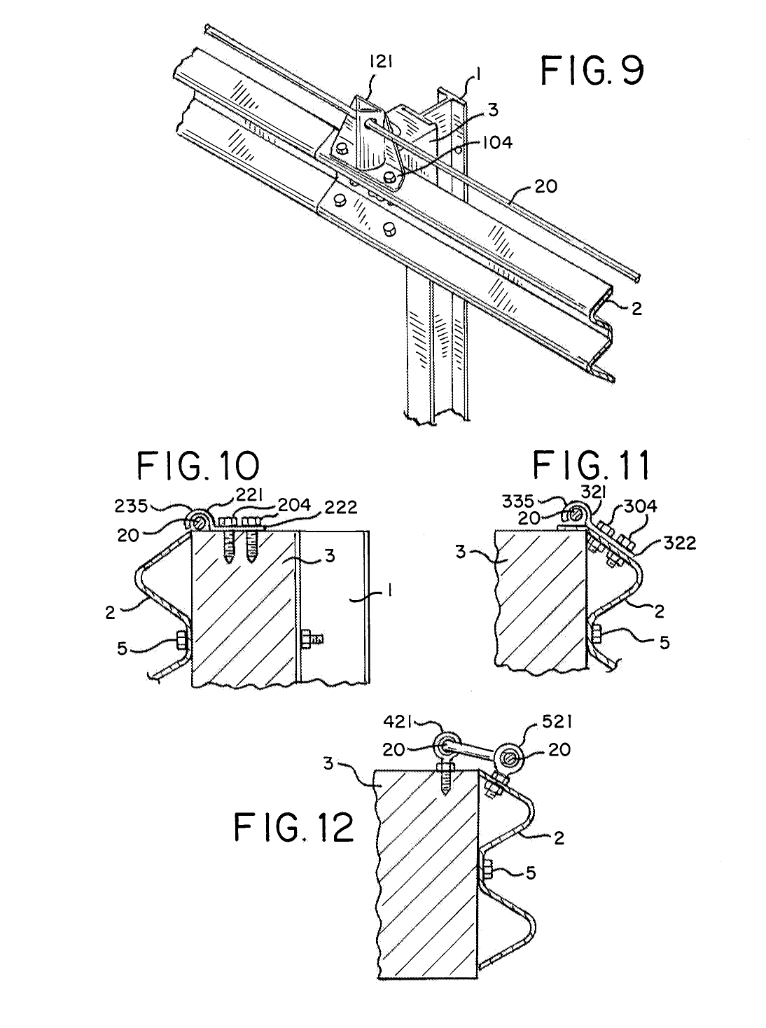

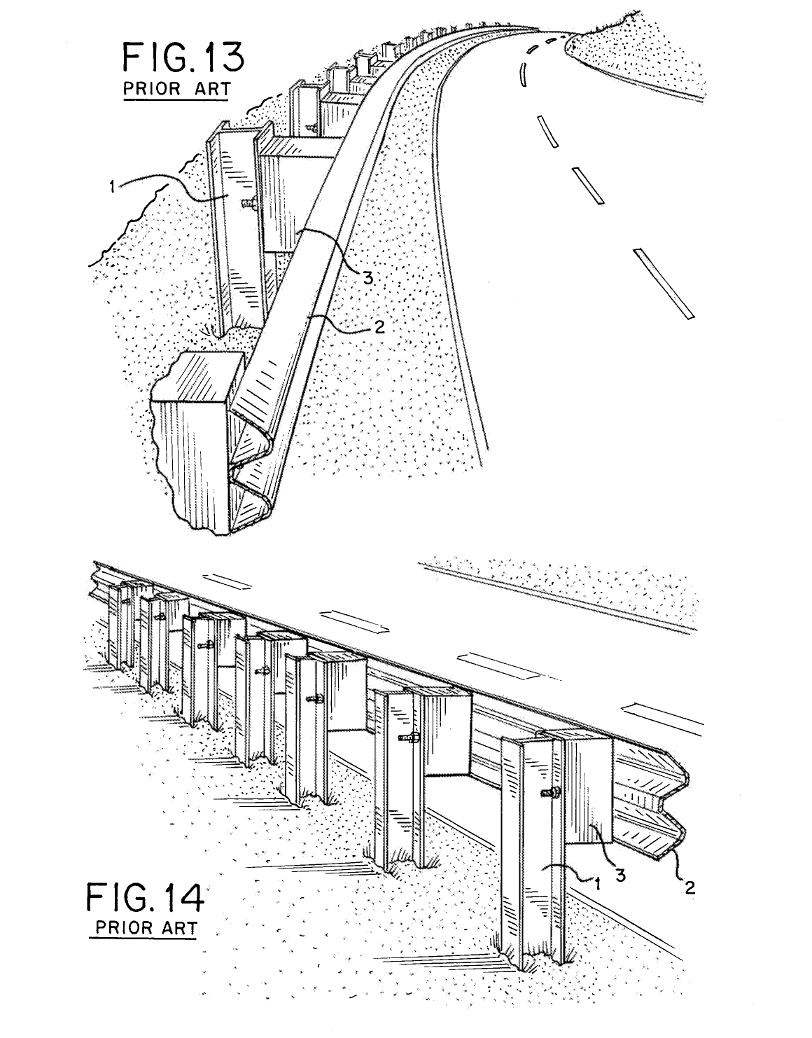

FIG. 9 shows an alternate embodiment that includes intermediate cable bracket 121 and release bolts 104. This design is different in the manner in which the cable is released from the rail section during an impact event. In particular, release bolts 104 are designed to fail once loading on the cable 20 reaches a predetermined limit. One or more release bolts 104 can be used depending upon the application. In this way, the cable 20 is held rigidly in place until the post 1 begins to rotate during the impact event. The cable 20 is then loaded, release bolts 104 fail, and the cable 20 is free to maintain its height above the ground, without being pulled down by the rotating post.

FIG. 10 shows another alternate embodiment that includes cable intermediate bracket 221 and release bolts 204. In this embodiment, cable bracket 221 holds the cable 20 rigidly during the initial impact, but then releases when a predetermined level of force is attained. For instance, cable bracket 221 may be configured with a base portion 222 and a cable retention tang 235 that will bend upwards or break at a predetermined level of force. In this way, the cable 20 is held rigidly in place until the post 1 begins to rotate during the impact event. The cable 20 is then loaded, cable retention tang 235 fails, and then the cable 20 is free to maintain its height above the ground, without being pulled down by the rotating post. Alternatively, one or more retention bolts 204 can be used to hold cable bracket 204 in place. These bolts can be designed to fail at a predetermined force either by pulling out of blockout 3, breaking, or pulling through cable bracket 221.

FIG. 11 shows another alternate embodiment that includes a cable intermediate bracket 321 and release bolts 304. In this design, cable brackets 321 hold the cable 20 rigidly during the initial impact, but then releases when a predetermined level of force is attained. For instance, cable bracket 321 may be configured with a base portin 322 and a cable retention tang 335, which will bend upwards or break at a predetermined level of force. In this way, the cable 20 is held rigidly in place until the post 1 begins to rotate during the impact event. The cable 20 is then loaded, cable retention tang 335 fails, and then the cable 20 is free to maintain its height above the ground, without being pulled down by the rotating post. Alternatively, one or more retention bolts 304 can be used to hold cable bracket 304 in place. These bolts can be designed fail at a predetermined force either by pulling out of guardrail 2, breaking, or pulling through cable bracket 321. A variety of bolt types could be used for retention bolts 304, including self-drilling, self-tapping type screws, as well as a traditional bolt with nut.

FIG. 12 shows other alternate embodiments that may include intermediate cable brackets 421 and 521. In these embodiments, cables 20 are threaded through the eyes of cable brackets 421 and 521 and the cables 20 are held rigidly during the initial impact. Although both cable brackets 421 and 521 are shown, either one or the other, or both could be used in a particular design. Two cables are shown, but this also would depend upon the needs of a design and one cable may be all that is necessary for a particular design. Once a predetermined level of force is attained the cables are released by a predetermined failure mechanism. Failure mechanisms that could be used include cable bracket 421 pulling out (stripping the threads) of blockout 3, cable brackets 421 or 521 breaking off at the connection between the eye and the threads, cable brackets 421 or 521 breaking off at the eye, cable brackets 521 pulling through a hole in rail section 2, and cable bracket 521 stripping off the nut that holds it in place, all of which are defined as releaseable fasteners.

Although the embodiments of FIGS. 10, 11, and 12 show the cable being held directly on top of the guardrail, whether by attachment to a post blockout or rail section, it should be understood that there are other cable bracket designs that hold the cable some distance above the guardrail, rather than directly on top of it.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A guardrail system comprising:
a plurality of posts spaced apart along a longitudinal direction;
a plurality of rail sections extending between and coupled to said spaced apart posts, each of said rail sections comprising an uppermost surface;
a cable extending along said longitudinal direction, wherein said cable is coupled to said rail sections and/or said posts, and wherein said cable is vertically spaced above said uppermost surface of said rail sections.

2. The guardrail system of claim 1 further comprising a plurality of brackets coupled to said rail sections and/or said posts, wherein said cable is coupled to said brackets and supported above said rail sections.

3. The guardrail system of claim 2 wherein said rail sections have overlapping end portions connected to said posts, and wherein at least some of said plurality of brackets are coupled to said overlapping end portions of said rail sections.

4. The guardrail system of claim 2 wherein said plurality of brackets includes a front anchor bracket, a rear anchor bracket and at least one intermediate bracket.

5. The guardrail system of claim 4 wherein said cable terminates and is coupled to said front and rear anchor brackets.

6. The guardrail system of claim 4 wherein said cable is placed in tension between said front and rear anchor brackets.

7. The guardrail system of claim 4 wherein said intermediate bracket comprises a cable release structure, wherein said cable is releasable from said intermediate bracket during an impact event.

8. The guardrail system of claim 7 wherein said cable release structure includes a vertically oriented retention slot comprising upper and lower notch portions, and a release slot communicating with said retention slot and opening through a side of said intermediate bracket.

9. The guardrail system of claim 7 wherein and cable release structure comprises a release tang.

10. The guardrail system of claim 7 wherein said cable release structure comprises at least one releasable fastener.

11. The guardrail system of claim 1 wherein said cable is coupled to said posts.

12. The guardrail system of claim 11 wherein said posts each comprise a blockout, and wherein said cable is coupled to said blockouts.

13. A guardrail retrofit kit comprising:
a front anchor bracket;
a rear anchor bracket;
an intermediate bracket;
a cable comprising end portions adapted to be coupled to said front and rear brackets, and wherein said intermediate bracket is configured to releasably capture said cable.

14. The guardrail retrofit kit of claim 12 wherein said intermediate bracket comprises a cable release structure configured to release said cable from said intermediate bracket during an impact event.

15. The guardrail retrofit kit of claim 14 wherein said cable release structure includes a vertically oriented retention slot comprising upper and lower notch portions, and a release slot communicating with said retention slot and opening through a side of said intermediate bracket.

16. The guardrail retrofit kit of claim 14 wherein and cable release structure comprises a release tang.

17. The guardrail retrofit kit of claim 14 wherein said cable release structure comprises at least one releasable fastener.

18. A cable retention bracket adapted to releasably capture a cable comprising:
a web having a vertically oriented retention slot comprising upper and lower notch portions, and a release slot communicating with said retention slot and opening through an edge of said web.

19. The cable retention bracket of claim 18 further comprising a release tang defining in part said upper notch portion.

20-31. (canceled)

32. A cable retention bracket adapted to releasably capture a cable comprising:
a base portion adapted to be secured to a rail section and/or post and a release tang connected to said base portion, said release tang shaped and sized to hold a cable in a non-impact condition, and said release tang configured to fail so as to release said cable during an impact condition.
